(19) United States
(12) Patent Application Publication
(10) Pub. No.: US 2022/0321517 A1
(43) Pub. Date: Oct. 6, 2022

(54) SYSTEM AND METHOD FOR COLLABORATIVE BROWSING OF WEBSITES AND APPLICATIONS AVAILABLE ONLINE

(71) Applicant: LiveChat Software S.A., Wroclaw (PL)

(72) Inventor: Filip Jaskólski, Wroclaw (PL)

(21) Appl. No.: 17/713,275

(22) Filed: Apr. 5, 2022

Related U.S. Application Data
(60) Provisional application No. 63/170,583, filed on Apr. 5, 2021.

(51) Int. Cl. H04L 51/216; G06F 3/0481; H04L 51/04; G06Q 30/06

(52) U.S. Cl. CPC H04L 51/216; G06F 3/0481; H04L 51/04; G06Q 30/0641; G06Q 30/0613

(57) ABSTRACT

This disclosure is directed towards the online communication over the webpage with the possibility of the direct conversation between end-users viewing the page. The disclosure uses a chat widget to facilitate communication between users with no need to install the system or login. There is an easy and accessible way of starting a conversation about a particular object displayed on screen for at least the first user viewing the page as well as the possibility to join already existing communication. The disclosed system and method steps provide a solution for webpage viewers to communicate instantly and to create the impression of community with the possibility to view other people who browse the page, start a conversation about a particular product or element of the display visible on screen.

### CROSS REFERENCE TO RELATED APPLICATIONS

This application claims priority to US Provisional patent application filed Apr. 5, 2021 and assigned Application No. 63/170,583, the content of which is herein incorporated by reference.

### BACKGROUND OF THE INVENTION

The present invention is directed towards the field of online messaging and the facilitating of group browsing experiences. Currently, online shopping or website browsing are one of the most fundamental acquisition channels for businesses. Even though there are a number of online website viewing technologies, as well as a number of communication channels, there are nevertheless in both situations no solutions for an end user-to-end user communication scheme. Depending upon whether the communication channel on the website disclosed messaging systems enables either agent to end-user communication or agent to automatic chatbot communication. Providing that online shopping or browsing experiences remain focused on a single user, currently available workflows and solutions limit focus on multiple users' communication on site.

Regarding the online shopping experience, it is a day-to-day practice of end-users to share links to the product, service, or any viewed webpage, to discuss the purchase or exchange experience with other users or acquaintances. Consequently, the flow of interaction with the webpage is being distracted by the external communication system connecting the person with another.

The present invention is directed towards the idea of side end user to end user communication facilitated with the use of an open and accessible chat widget. Consequently, the area of art related to this invention is online communication via network and on-site use of chat widget to facilitate the communication between at least a first and second user.

At present, known solutions are not fully addressing the above-listed issues and, to the extent such solutions exist, they are cumbersome, ineffective, and tend to create a need for communication channels switching from the viewed webpage to the instant communication channel which distracts the user and makes it even more difficult to point at certain elements of the product presented on the webpage due to the external link and communication run on a separate communication channel. On the other hand, on-site communication is directed towards the end-user to an agent or end-user to the chatbot and consequently leaves no space for on-site end-user to end-user communication.

### BRIEF SUMMARY OF THE INVENTION

The present disclosure is directed to the area of on-site real-time communication directed towards consumer-to-consumer communication (or end-user to end-user communication). The present invention is directed to bridging the gap between the physical and online shopping experiences and also to transform the former into a more personal and inclusive form. In regular offline shopping or browsing, a person can experience the ability to talk with other participants, ask about products, and interact with persons being in the same area. The online experience is effectively emptied of this experience and as a consequence leaves the technological gap of consumer-to-consumer communication on site.

As the website is the natural environment of the online shops, this also serves as the right place to facilitate online communication between end-users viewing the page or particular product subpage. The present invention is technologically based on a chat widget that is located on-site and that is further enabled for all end-users viewing the page. The chat widget is configured in such a way that it enables the communication between viewers of the page with no need to log into the system or register and that further includes the possibility of asynchronous communication.

The disclosed invention is further configured in such a way as to enable to pin the chat widget communication to the particular element presented on the webpage, as for example a product displayed on the page, to initiate communication with other webpage viewers.

The present disclosure is designed in such a way as to enable other webpage viewers to join the communication and as an outcome to accept multiple users in one communication thread. What is more, the disclosed invention is designed in such a way as to enable one to leave the webpage and come back to it with the communication thread being continued.

### BRIEF DESCRIPTION OF THE SEVERAL VIEWS OF DRAWING

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

In the following, advantageous examples of the invention are explained with reference to the accompanying figures, wherein:

FIG. 1 depicts the simplified flow of communication between invention elements including end-user interaction with the webpage;

FIG. 2 depicts the communication widget displayed on the product webpage with chat communication already pending between two end-users;

FIG. 3 depicts the simplified flow of communication between invention elements including end-user interaction with the webpage with virtual storage, database, and messaging service included;

FIG. 4 depicts the communication flow between messaging service, communication node, and pinning node;

FIG. 5 depicts a communication widget displayed on the product webpage with a communication thread being pinned to the particular element of the content displayed;

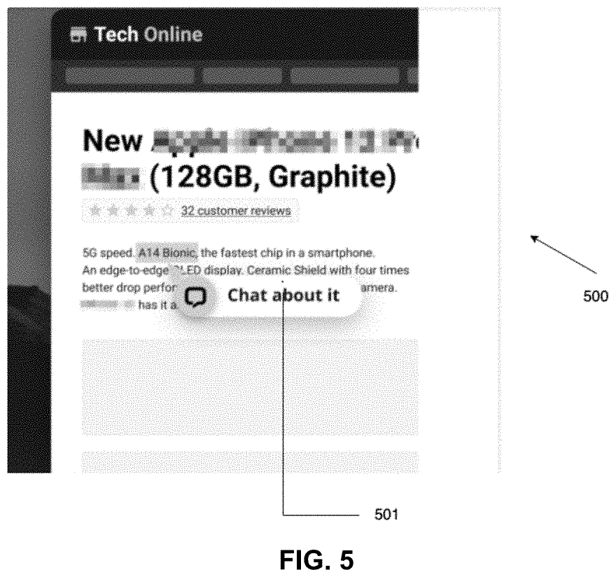

FIG. 6 depicts the detailed flow of multiple users accessing the communication widget;

FIG. 7 depicts a communication widget displayed on the product webpage with a communication thread being pinned to the particular element of the content displayed within the context of the whole webpage;

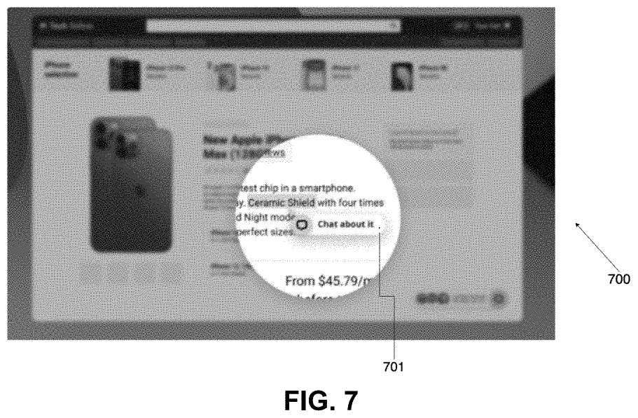

FIG. 8 depicts a communication widget displayed on the product webpage with a communication thread being pinned to the particular element of the content displayed within the context of the whole webpage with two users browsing; and

FIG. 9 depicts a communication widget displayed on the product webpage with a communication thread being pinned to the particular element of the content displayed with two users browsing.

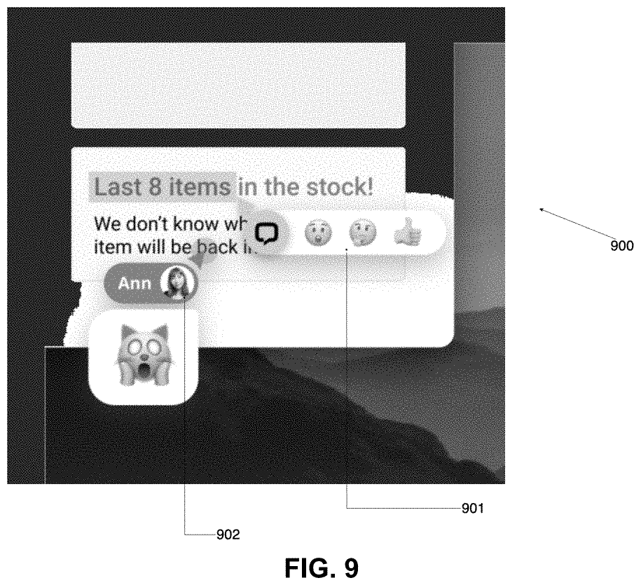

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of” “A, B, and C” should be understood as including only one of A, only one of B, only one of C, or any combination of A, B, and C. In the figures, the same or functionally identical elements have been provided with the same reference signs.

Solutions dedicated to real-time business-to-customer conversations are interesting to the field of customer-to-customer communication as well. This invention is directed to bridge the gap between the physical and online shopping experiences and also to transform the former into a more personal and inclusive form. The online browsing experience strips out the serendipity of various and seemingly random people's encounters by at least removing the chance to interact with other website visitors. Such solutions aim to socialize Internet browsing by making website visitors visible to one another as well as seeing each other's activity and interactions on the web page's canvas. Advantageously any website visitor may join the experience without downloading any additional software, thereby making the instant solution more readily accessible and unintimidating to a wide variety of potential and/or interested users. The functionalities are delivered through the code snippet embedded on the website.

Furthermore, the invention is directed towards the online co-browsing sphere that happens over the Internet via networked devices and engages both visitors and representatives of entrepreneurs (for example agents or customer support specialists). An aim of the present invention is not only to mitigate the human and/or interpersonal and/or social isolation of online browsing or shopping, but it is also a means to faster and more efficient communication between individuals in an online environment.

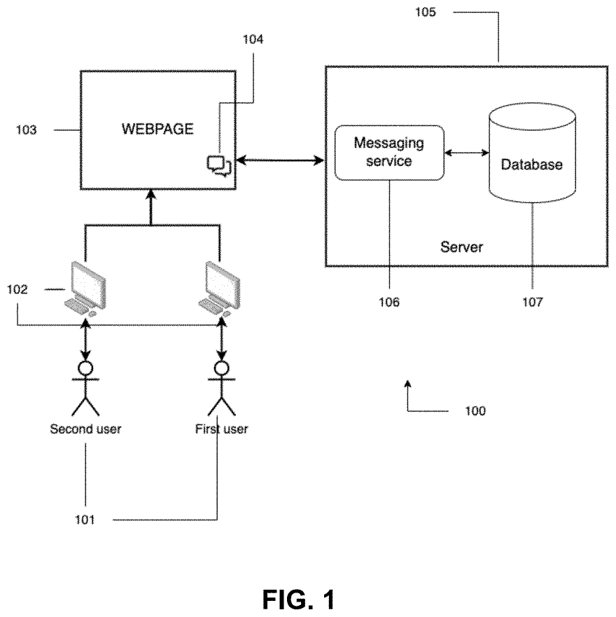

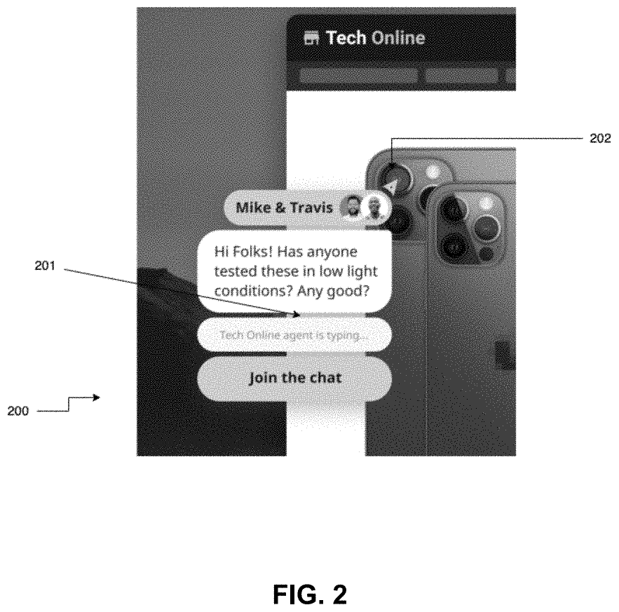

By way of example, the present invention is directed to a system that enables interactive multi-media chat communication over a webpage that shall be available for the webpage visitors and agents that operates between at least a first and a second processor. Starting with FIG. 1 and by the way of example, the present system enables the first user and a second user (101) operating via personal processors (102) to access the webpage (103) with the disclosed system enabled and to communicate via chat widget (104) together with no need to include chat agent operator or any additional system installation. The system is further facilitated via server (105) with the messaging system (106) configured in communication with the database (107). Such communication further includes activities such as pinning a chat to content, image, or another element of the canvas of the webpage (202); a visitor-to-visitor communication group chats about the object present on the canvas that includes an unlimited number of participants (201). FIG. 2 depicts an example of two users, Mike and Travis, already chatting about the displayed product and the chat widget configured with the possibility to join the chat communication by other users (201). By default, the chat thread is visible for all viewers of the page, and as long as the thread remains open, all viewers can join and view previous messages. If users decide to hold a private chat between each other, they open the thread from the page and thus hide it from other viewers.

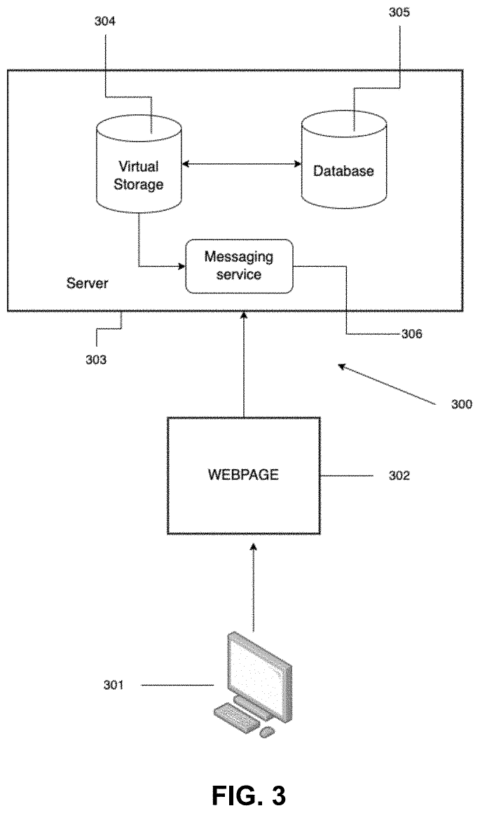

As depicted in FIG. 3, by the first processor, Applicant means a computer of a first user (301) with a networked connection and an Internet browser (302) that leverages local storage and that also communicates via web APIs with a remote data storage infrastructure and a data processing system (303). The computer may be further used interchangeably with the mobile device with the access to the Internet and web browser. The system further includes a set of web services such as virtual storage (304) and messaging service (306) and server (303) that communicate with the second processor of a second user that operates on the same webpage via an Internet browser with local storage and also a networked connection. Messaging service (306) is responsible for messaging functionality (creating a message and sending) that facilitates data exchange between at least the first and the second user over the network and chat widget enabled on the webpage (302). Messaging service uses API to communicate with external services and databases as well as communication channels.

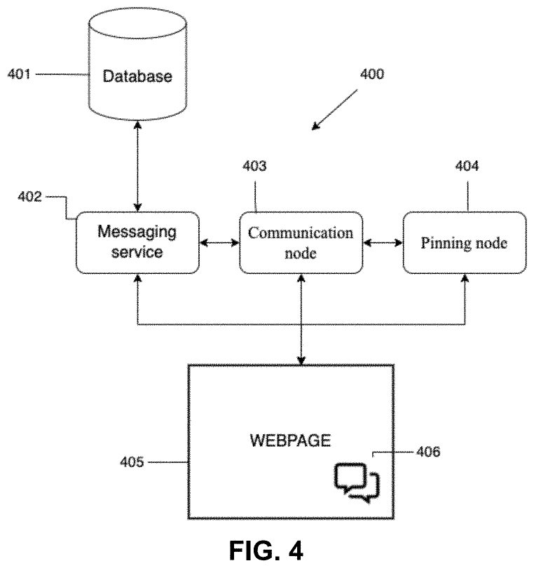

As depicted in FIG. 4, an embodiment of the present invention also includes a communication node (403) arranged in connection with the chat widget (406) located on the webpage (405) that facilitates the exchange of information between the first and the second user. Consequently, data sent by the first user via chat widget are further saved in the database (401) with the use of messaging service (402). The communication node (403) assigns the communication thread to the right users. The present invention also enables the pinning of the element to the selected element of the webpage as for example: image, what is performed by the pinning node (404) that saves the element to which the chat widget shall be assigned, and manages the further display of the assigned chat widget to the other webpage visitors. Furthermore, the invention suggests to the visitor to start a chat communication once the user highlights the element. For example, when the user selects a piece of text (highlight), the suggestion to chat about it is displayed on the screen of this user which initiates a communication thread (501).

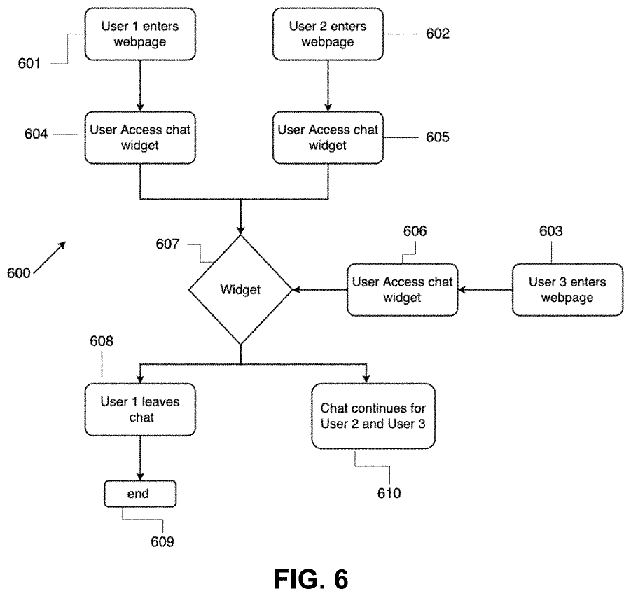

By way of an embodiment of the present invention, the disclosed system facilitates communication between individuals over a webpage with a widget code (also referred to as a web live chat tracking code snippet). By the chat code, one should understand an element of the infrastructure of a website or web application that is responsible for invoking, communicating with, and recording transcripts of conversations conducted via a chat window. Chat code, regardless of its form, has a tunneling function for a given medium such as a website. Invoking a communication channel code (FIG. 6) such as chat allows this discloser of the invention to function and establish a direct communication channel (604) for other users browsing the website without installing any additional software. This embodiment assumes multiple users' (601, 602, 603) ability to access the communication channel (widget, 607). It further enables that if one user (601) decides to leave the chat (608) the chat ends for this user (609) but nevertheless remains operating for all others (602, 603) and continues in the same thread (610). The communication for a particular user starts when the user accesses the chat widget (604, 605, 606).

The present invention benefits from instant channels of communication such as chat that introduces a chat code to the webpage and enables further communication with agents started directly from the chat widget (702). Consequently, further to the disclosed invention, a solution located within the context of a webpage (700) may serve for both end-user to end-user communication as well as agent to end-user. By agent, it should be understood as a representative of customer care of the company that delivers the webpage for the purpose of product or service promotion. This facilitates communication that begins on the webpage and may be attached to particular elements of the page canvas like images, drawings, content and start a conversation about an element displayed on the screen of the first user and further available for the plurality of users that operates on the same webpage with the invention applied. It enables messaging interactions for unlimited participants. Once the visitor starts a chat, business representatives may join, as well as other website visitors. Both the visitors and businesses may initiate the described communication channel. The solution covers several use cases:

a. customer to business communication (e.g., a customer requesting help with the product),
b. customer to customer communication (e.g., a customer asking for another customers' opinion), and/or
c. business to customer communication (e.g., a sales representative offering a limited discount for and/or to the customer(s)).

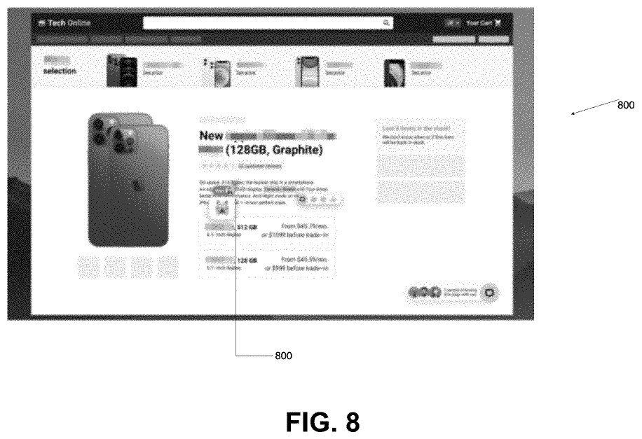

Any of these use cases may leverage the network of website visitors to facilitate interaction between them. As disclosed in FIG. 8, visitors can see other visitors browsing the webpage at the moment and interact with them (801). It is further possible to leave only non-verbal, emoticon reactions to the message of the other user or content displayed on the webpage (901). With all interactions, the user can see other users viewing the page and leaving content or reactions to what is displayed on the screen (902).

An embodiment of the present invention uses local storage and browser sessions to collect data from a plurality of users about their presence and activity on the webpage. To facilitate this, an embodiment of this invention provides any webpage with the chat code installed in a special interface where the user can define if his or her presence on the webpage should be visible to other users and if so, this embodiment further enables the user (also referred to as a visitor) to start a conversation with at least one of the agents representing a business or another visitor on the webpage. It further allows an agent that uses the webpage with the invention operating on it to start a conversation with the visitor. When the first embodiment of the user starts the conversation with, for example, another user (visitor) the conversation entered into the chat widget is saved on the physical remote storage (server) further communication between the server, invention's APIs, and databases enabling this embodiment of the invention to save the data entered in the conversation window in case of session stability drop, the exit of one of the users or future come back of at least one of the users taking part in the conversation to a thread. By looking at the chat structure, it is visible and understood that each chat is divided into threads and consequently every thread contains events, for example, sending messages or images. This construction enables distinction between a chat as a whole conversation, while threads are separate conversation topics.

The following is an example application with respect to an online store. Thread-based construction of a chat enables the embodiment of the invention to further continue communication in case of the following scenario: a customer starts a chat to ask about the shoes they bought. If they do not have any previous chat history, a new chat may be started. Within this chat, a new thread may be created (conversation topic). The messages they exchange with the customer service assistant are received by the thread as events. After solving the problem, the customer says goodbye and closes the chat, which automatically closes the thread. Let's say the customer does not end the chat effectively. In this case, the thread closes after 30 minutes of inactivity (other time periods being configurable by way of other embodiments), but the chat doesn't end. The next day, the customer returns to ask about his or her other purchase. A new thread starts in the context of the chat, which has been continuously open. Each time a customer returns and starts a new conversation topic, they need to click start a chat. Following our naming convention, that would start a thread. A message or any equivalent type of content is not the only event type. There are also special events for specific actions, like files, filled forms, systems, and custom messages. Various content and event types that are stored at the local storage and further passed to the data storage center enable the embodiment of the invention to continue communication that is pinned to the element or content by the first user and further facilitates the communication between at least the first and the second user. When a new chat is started, a new active thread is created within this chat.

New threads within a single chat are orchestrated on the server-side by the logic of the system. There is always only one active thread within a single chat. By way of an embodiment, only the last thread within a single chat can be the active one. Events are always added to the active thread. It is possible to have time gaps between threads in a chat, but once a chat is started, it's continuously open. Consequently, messages are sent and delivered even when the recipient (both Customer and Agent) is offline. Multiple Agents can participate in a single chat and every user can have multiple concurrent chats. To facilitate both asynchronous messages and real-time communication, API is provided in this embodiment of the invention which can be used either as Real-Time Messaging APIs (RTM APIs) or Web APIs using a structure of webhooks or pushes that communicates respectively over a WebSocket or stateless, via XHR requests.

Furthermore, the invention enables group browsing that facilitates the participants to join co-browsing sessions. When in a session, the host browses the website, while other participants automatically follow. Co-browsing is defined as being present on the webpage during one session while other visitors are viewing the same webpage and following the host's actions. In this disclosure of the embodiment, the processor of a first user operates with a browser and all its native APIs that further use sessions to save data in its cache memory. Once the first user, also referred to as a visitor, agrees to be visible as browsing, other visitors with the same browsing session can see the first user and see the cursor of the person during browsing to preview the focus. Co-browsing covers the following use cases:

a. customer support (e.g., a customer service representative explaining product features to a customer),
b. sales (e.g., a sales representative showing around offerings to multiple customers at once, in the form of an online event), and/or
c. affiliate & influencers marketing (e.g., a customer reviewing the product for other customers).

Aside from starting a chat and browsing, the system enables the pinning of the conversation to specific parts of the website, which transforms static web pages into interactive canvases for human conversations. While starting a conversation, the participant may pin a chat widget down to a specific part of the web page. The conversation then remains in a particular spot (called chat anchor). The participants may then decide if the pinned chat is persistent or ephemeral. Persistent chats remain pinned to the web page and are available to be joined asynchronously for days after the chat was started. They may serve the following use cases:

a. customer community & reviews (e.g., persistent pinned chats act as social proofs or product reviews),
b. business workload optimization (e.g., customers help each other, without the need of the business to engage), and/or
c. customer support (e.g., customers ask a question regarding a specific product).

The pinning functionality relies on the native structure of websites and web apps. While pinning a chat, a specific element of the website is selected: text node of a paragraph, an image, or other objects. The selected object has its unique parameters, including the visual location on the page and also position within the cross-platform Document Object Model (DOM) interface. These parameters are associated with the chat and stored securely to be retrieved every time the pinned chat is being rendered. This embodiment of the invention further refers to the canvas of a webpage where chat code installed can distinguish a particular element, as for example—an image, and further display this image along with content or reaction performed by the first user to a second user.

What is more, the next disclosure of the invention, enables visitors of the webpage (being at least the first or second user of the invention) to create an activity feed that makes it possible for the visitors to receive updates on their activities. The appropriate information is presented inside the chat widgets. The activity feed is central to the real-time experience and may act for the following use cases:

a. visitor notifications (e.g., a new participant joins, a new chat is started),
b. audience engagement (e.g., a participant is encouraged to join a chat that just started), and/or
c. archives analysis (e.g., a business owner reviews the session after it ended).

Activity feed enables users to view other users that are currently browsing the same page within one session. This embodiment of the invention allows users to view activities of other users that are presented in a form of a log concerning certain actions. In the case of user A doing action B on the webpage, it leaves an entry in the activity feed marked with a timestamp. Actions taken by user A are saved within local storage and transferred to remote storage of the system if necessary. Then they're displayed in a form of a widget displaying entries about the activity.

Furthermore, an embodiment of the invention enables visitors to express their opinions about particular parts of the web page. Once a visitor selects an element or piece of text, they're presented with a list of emojis to pick as their reaction. Reactions cover the following use cases:

a. engagement (e.g., visitors express their opinions in a web-native way with emojis), and/or
b. feedback collection (e.g., a business representative reviews their customers' reactions).

By way of further example, the present invention is directed to a system that transforms a static business website into an interactive and living community of and for its visitors. Thanks to the combination of synchronous and asynchronous ways of expressing thoughts, emotions, and opinions, the present invention provides a set of tools for business owners to improve the quality of their customer service. The present invention transforms the current landscape of online shopping into a more social and human experience, empowering consumers to form communities and interact with brands like never before.

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed is:

1. A system for collaborative website browsing combined with an instant communication channel, the system comprising:
at least one instant communication widget arranged on a website or online application;
at least one first user processor configured to access a widget;
at least one second user processor configured to access the widget;
a server arranged in communication with the widget;
a messaging service arranged on the server and configured to continue communication threads displayed via the widget;
a database configured to save communication threads displayed via widgets and arranged on a server; and
wherein a communication widget is available on the website for all users with no prior registration required.

2. The system according to claim 1, wherein the communication widget further comprises:
a user input configured to accept at least one of textual content, alphanumeric content, audio, video and static graphic content;
a user display configured to present chat availability and send and received messages in the communication thread;
wherein the communication widget can be pinned to the selected screen element via at least the first or the second user; and
wherein the communication widget can be accessed by all website visitors.

3. The system according to claim 1, wherein the server further comprises:
a virtual server configured to save data including communication threads arranged on a physical server; and
wherein the messaging service and the database are configured on the virtual server; and
wherein the server is arranged in communication with the chat widget.

4. The system according to claim 1, wherein the messaging service further comprises:
a communication node configured to collect the communication threads from communication widgets and saving the communication threads in the database;
a pinning node configure to pin the communication widget to the selected element on the user interface on the website displayed on the at least first or second user processor; and
wherein the communication widget pinned with the pinning node can be removed by the at least one of the first and the second user.

5. The system according to claim 1, wherein the database is further configured to:
save the data of communication threads sent by the messaging service;
save the data about the communication widget users;
remove the data of communication threads after a predefined amount of time to optimize data storage space;
remove the data about the communication widget users after a predefined amount of time to optimize data storage space; and
wherein the data about the communication widget users are collected via cookies, local storage or pre-chat survey.

6. The system according to claim 2 wherein the communication widget further comprises:
a new widget trigger that opens the chat widget for a new communication thread;
a currently existing widget trigger that open the chat widget for already existing communication thread; and
wherein at least the first user can access currently available communication widgets started can be accessed by other users; and
wherein all communication threads are available for both real-time and asynchronous communication.

7. The system according to claim 4 wherein the communication node is further configured to:
enable starting the communication via communication widget by at least one of the first and the second user;
enable continuing communication asynchronously via communication widget by at least one of the first and the second user;
enable removing the communication via communication widget by at least one of the first and the second user; and
enable joining the communication via communication widget started by the other user.

8. The system according to claim 5, wherein the pre-chat survey is configured to accept at least one of audio, video, textual and alphanumeric content.

9. The system according to claim 5, wherein the pre-chat survey is configured to be available upon the website administrator configuration of the communication widget used by at least the first and the second user.

10. A method for collaborative website browsing combined with an instant communication channel, the method comprising the steps of:
displaying an instant communication widget and arranging the communication widget on a website or online application;
accessing the communication widget by at least one of the first user and the second user;
typing a message by at least one of the first user and the second user via the communication widget displayed on the processor;
sending a message via the communication widget by the first user to the second user with the use of the communication widget;
continuing communication threads displayed via the communication widget in case the user leaves the website and comes back;
saving the communication threads displayed via widgets in the database arranged on the server; and
wherein the communication widget is available on the webpage for all users with no prior registration required.

11. The method according to claim 10, further comprising the steps of:
triggering the communication widget by at least the first user viewing the website;
typing a message including at least one of textual content, alphanumeric content, voice, video or graphic content by at least the first user on the first user processor;
sending the message typed by the first user to the second user;
saving the message sent by the first user to the second user;
displaying the message sent by the first user via the communication widget to the second user in the communication thread displayed on the second user processor; and
wherein the communication widget can be pinned to the selected screen element via at least the first user and the second user; and
wherein displaying the message sent by the first user can be accessed by all website visitors entering the communication thread.

12. The method according to claim 10, further comprising the steps of:
saving the data including communication threads on a virtual server arranged on a physical server; and
Wherein saving by the messaging service and database is configured on the virtual server; and
wherein the saving on the virtual server is arranged in communication with the chat widget.

13. The method according to claim 10, further comprising the steps of:
collecting the communication threads from communication widgets and saving the communication threads in the database by the communication node; and
pinning the chat widget to the selected element of website by the at least one first user to trigger the communication widget with the pinning node; and
wherein pinning of the communication widget with the pinning node can be removed by the at least first user and the second user.

14. The method according to claim 10, further comprising the steps of:
saving the data of communication threads sent by the messaging service;
saving the data about the communication widget users;
removing the data of communication threads after a predefined amount of time to optimize data storage space;
removing the data about the communication widget users after a predefined amount of time to optimize data storage space; and
wherein collecting the data about the communication widget users is arranged via cookies or pre-chat survey.

15. The method according to claim 11, further comprising the steps of:
triggering a new communication widget that opens a new communication thread;
triggering a currently existing communication widget for already existing communication thread; and
wherein at least the first user can access currently available communication widgets started can be accessed by other users; and
wherein all communication threads are available for both real-time and asynchronous communication.

16. The method according to claim 13, further comprising the steps of:
Staring the communication via the communication widget by at least one of the first user and the second user;
continuing the communication asynchronously via the communication widget by at least one of the first or the second user;
removing the communication via communication widget by at least one of the first or the second user; and
joining the communication via communication widget started by the other user;
